(19) United States
(12) Patent Application Publication
(10) Pub. No.: US 2010/0230877 A1
(43) Pub. Date: Sep. 16, 2010

(54) VEHICULAR IMPACT BUMPER ASSEMBLY

(75) Inventors: JOSEPH A. SCHUDT, MACOMB, MI (US); DARYL R. POIRIER, DAVISBURG, MI (US); RAVINDRA P. PATIL, TROY, MI (US); ROBERT L. GEISLER, GRAND BLANC, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/403,541

(22) Filed: Mar. 13, 2009

(51) Int. Cl. F16F 11/00

(52) U.S. Cl. 267/220; 267/195

(57) ABSTRACT

An impact bumper assembly for a vehicle is provided. The assembly comprises a first member, and a second member coupled to the first member and configured for relative motion therewith. The assembly also comprises a resilient bumper coupled to the first member and interposed between the first and second members, wherein the resilient bumper has an annular wall having a plurality of openings therethrough, and wherein the resilient bumper is configured to deform axially without substantial radial deformation when compressed between the first and second members.

### TECHNICAL FIELD

The present invention generally relates to vehicular suspension systems, and more particularly relates to an impact bumper assembly for a vehicular suspension system.

### BACKGROUND OF THE INVENTION

Vehicles are typically equipped with suspension systems that generally include a multitude of springs, linear actuators, damper assemblies such as shock absorbers and/or struts, interconnecting support members, and the like that compress and expand to provide flexible relative movement between the body and chassis. During normal driving conditions, these components gradually dissipate the forces generated by bumps, potholes, and other road conditions in a controlled manner that maintains passengers in a safe and comfortable driving environment.

However, severe impact events can impose excessive loading on a suspension causing it to contract beyond the designed operating range of springs and shocks/struts. Excessive jounce, or downward motion of the body toward the chassis, can lead to potentially damaging collisions between suspension components and/or other undercarriage elements. To prevent such damage, many suspension systems employ impact load management systems that limit jounce. Such systems typically include jounce bumper assemblies configured to engage during severe impact events and provide a “bottoming” or a limit to further contractive motion. These assemblies may be used to limit jounce between, for example, sprung and unsprung vehicle masses and may be conveniently located within the body of a shock or strut. Such integrated assemblies typically include a rigid metallic striker plate coupled to the end cap of the damper tube and a polyurethane foam-based or rubber jounce bumper coupled to the upper mount. Each is aligned along a common piston rod and spaced apart so that, during an impact event, the striker cap and jounce bumper engage causing the bumper to deform axially along the piston rod in the direction of loading. However, such a configuration provides little cushioning effect from impact loads because of the rigidity of the striker plate and the marginal capacity of the foam rubber bumper to absorb associated energy. As a result, striker plates, jounce bumper mounts, body structure, frame structure, and/or other structural elements can receive the brunt of impact loads making them susceptible to damage. Accordingly, these and other similarly affected elements are generally designed with a more rugged construction of greater mass and volume than would otherwise be required if the jounce bumper assembly were more energy absorbing. Such a design adds to the overall weight and expense of damper assemblies, and reduces their space efficiency.

Accordingly, it is desirable to provide an impact bumper assembly for a suspension system having improved energy absorption during impact events. Further, it is also desirable if such an assembly has geometrical stability when loaded, and greater space efficiency for both loaded and unloaded states. Furthermore, it is also desirable if the assembly enables the use of less rugged and more lightweight structural supporting components. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

In accordance with an embodiment, by way of example only, an impact bumper assembly for a vehicle is provided. The assembly comprises a first member, and a second member coupled to the first member and configured for relative motion therewith. The assembly also comprises a resilient bumper coupled to the first member and interposed between the first and second members, wherein the resilient bumper has an annular wall having a plurality of openings therethrough, and wherein the resilient bumper is configured to deform axially without substantial radial deformation when compressed between the first and second members.

### DESCRIPTION OF THE DRAWINGS

A more complete understanding of the present invention may be derived by referring to the detailed description and claims when considered in conjunction with the following figures, wherein like reference numbers refer to similar elements throughout the figures, and

FIG. 1 is a plan view of an exemplary vehicle illustrating a manner in which an embodiment is integrated with various sub-components of the vehicle;

FIG. 2 is a isometric view of an exemplary suspension damper assembly for use with the vehicle depicted in FIG. 1, and having an integrated impact bumper assembly in accordance with another exemplary embodiment;

FIG. 3 is a cross-sectional isometric view of the impact bumper assembly integrated into the suspension damper assembly depicted in FIG. 2;

FIG. 4 is an isometric view of an impact bumper assembly integrated between two suspension members in accordance with another embodiment; and

FIG. 5 is an isometric view of an impact bumper assembly integrated between two suspension members in accordance with yet another embodiment.

### DESCRIPTION OF AN EXEMPLARY EMBODIMENT

The various embodiments of the present invention described herein provide an impact bumper assembly integrated between two suspension members for managing impact load for a vehicular suspension. The assembly is configured to absorb energy during impact events characterized by excessive contractive relative motion between the body and chassis of a vehicle (jounce), and may be mounted between suitable suspension members wherein it is desirable to limit such excessive jounce motion. The assembly may be used in a standalone manner, or may be integrated within the body of a damper assembly such as a shock absorber or a strut. The assembly includes a resilient annular impact bumper coupled between two suitable suspension members and configured to compress axially during impacting events, absorbing energy from the impact load thereby, without substantial radial deformation. The radial geometric stability of the impact bumper during axial deformation also improves the space efficiency of the overall design.

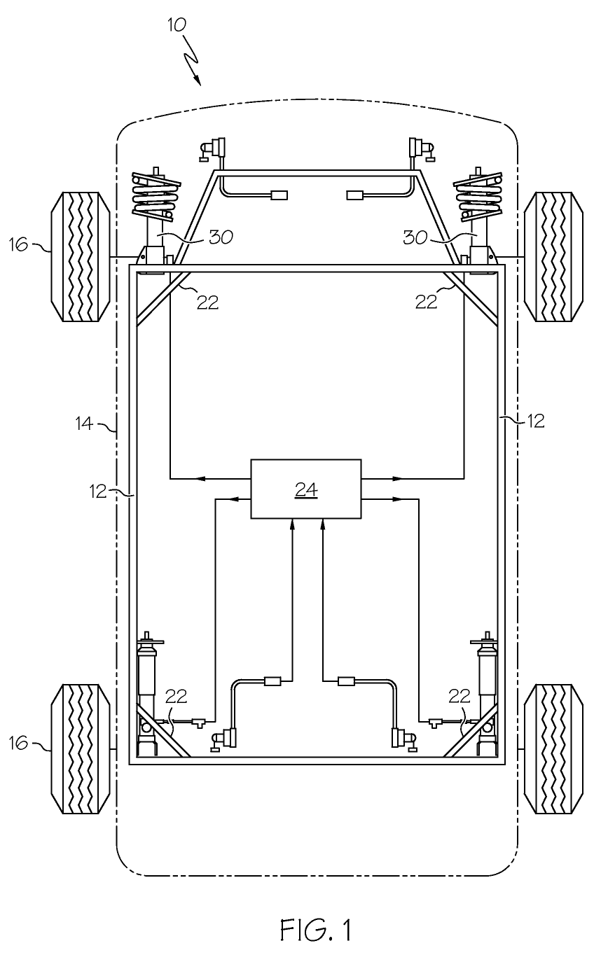

FIG. 1 is a plan view illustration of a vehicle 10 (e.g., an automobile) for use in conjunction with one or more embodiments of the present invention. Vehicle 10 includes a chassis 12, a body 14, four wheels 16, a suspension assembly 22, and a chassis control module (or CCM) 24. Body 14 is arranged on chassis 12 and substantially encloses the other components of vehicle 10. Body 14 and chassis 12 may jointly form a frame. The wheels 16 are each rotationally coupled to chassis 12 near a respective corner of body 14. Suspension assembly 22 is configured to provide a damped and stabilized coupling between a sprung vehicle mass including body 14, and an unsprung mass including wheels 16 and a portion of chassis 12. Suspension assembly 22 may include springs, linear actuators, control arms or links, and other interconnecting and supporting members, and further includes at least one damper assembly 30 such as a shock absorber or a strut, or the like, for dampening relative motion between sprung and unsprung vehicle masses. Damper assembly 30 may be configured for passive response, or may be designed to respond actively on command from CCM 24 in real time by making adjustments to suspension assembly 22 depending on road surface conditions to stabilize body 14. Damper assembly 30 also contains an impact bumper assembly that includes an integrated impact bumper to be described in greater detail below. This bumper assembly is configured to absorb energy in a geometrically stable and space efficient manner during suspension impact events caused by excessive jounce or contractive motion between body 14 and chassis 12.

Vehicle 10 may be any of a variety of vehicle types, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). Vehicle 10 may also incorporate any one of, or combination of, a number of different types of engines, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor hybrid engine, and an electric motor.

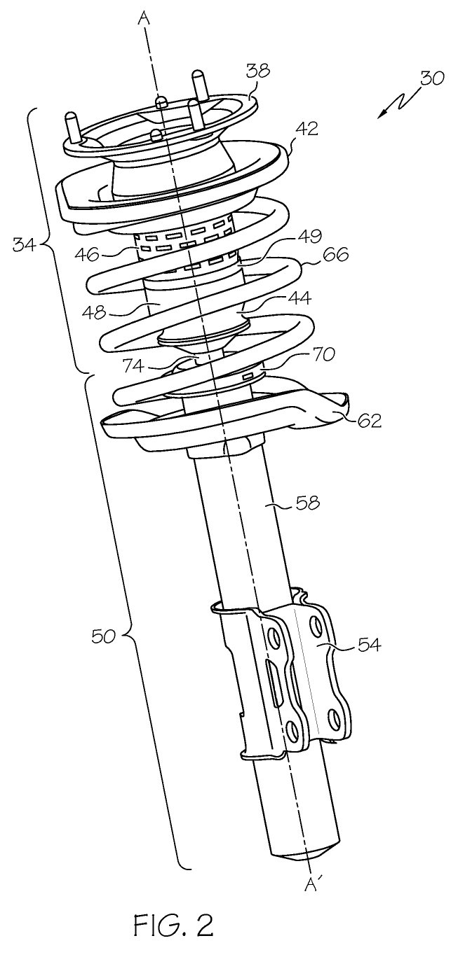

FIG. 2 is an isometric illustration of damper assembly 30 containing an impact bumper assembly in accordance with an exemplary embodiment. Damper assembly 30, which may comprise a shock absorber, a strut, or the like, is attached between any two suitable components of suspension assembly 22 (FIG. 1) to dampen relative motion therebetween, such as, most commonly, sprung and unsprung vehicle masses. Assembly 30 has a first portion 34 that includes an upper mounting bracket 38, an upper spring seat 42, a jounce bumper 44, an impact bumper 46, a jounce cup 48, and a support ring 49. Assembly 30 also includes a piston rod 74 rigidly coupled to upper mounting bracket 38, and slidably coupled to and axially aligned (aligned along axis A-A′) with a second portion 50 of damper assembly 30 that includes a lower mounting bracket 54, a cylindrical damper tube 58, a lower spring seat/retainer 62, and a striker cap 70. Damper assembly 30 may also include a dust tube or dust boot (not shown) coupled to upper spring seat 42 and circumscribed about sections of first and second portions 34 and 50 to reduce the susceptibility of internal components to road contamination. First and second portions 34 and 50 are each substantially rigidly attached to suitable suspension members (not shown) such as, for example, sprung and unsprung vehicle masses using upper and lower mounting brackets 38 and 54, respectively, in conjunction with fasteners in a conventional manner.

Damper assembly 30 also includes a coil spring 66 circumferentially disposed about first and second portions 34 and 50, and aligned substantially parallel to damper tube 58. Coil spring 66 is bounded between and retained in place by upper spring seat 42 and lower spring seat/retainer 62. Jounce bumper 44, impact bumper 46, jounce cup 48, and support ring 49 are stacked in a columnar configuration, each of these elements coupled to and circumscribed about piston rod 74, and configured to move substantially in unison therewith. Impact bumper 46 is coupled at one end to upper spring seat 42, and to support ring 49 at the other end. Jounce bumper 44 is coupled to jounce cup 48 at one end and, during impact events, is configured to deformably engage striker cap 70 mounted to an end of damper tube 58. When vehicle 10 is in motion, piston rod 74 moves in and out of damper tube 58 substantially along axis A-A′ (axial motion) contracting and expanding assembly 30 in a well known manner to dampen such relative motion. Coil spring 66 provides resilient forces as necessary tending to restore an equilibrium relative height between sprung and unsprung masses.

During impact events, excessive jounce occurs between connecting suspension members that is transferred to damper assembly 30 through upper and lower mounting brackets 38 and 54. First and second portions 34 and 50 contract beyond a normal operating range causing jounce bumper 44 to deformably engage against striker cap 70. Impact load energy is transferred from jounce bumper 44 through jounce cup 48 and support ring 49 to impact bumper 46. Impact bumper 46 absorbs energy from the impact load and responds by compressing axially between upper spring seat 42 and support ring 49 without substantial radial deformation, in a manner to be described in detail below. When the relative height between suspension members rebounds to a normal range, jounce bumper 44 and impact bumper 46 are each substantially restored to an unloaded, non-deformed, geometric configuration.

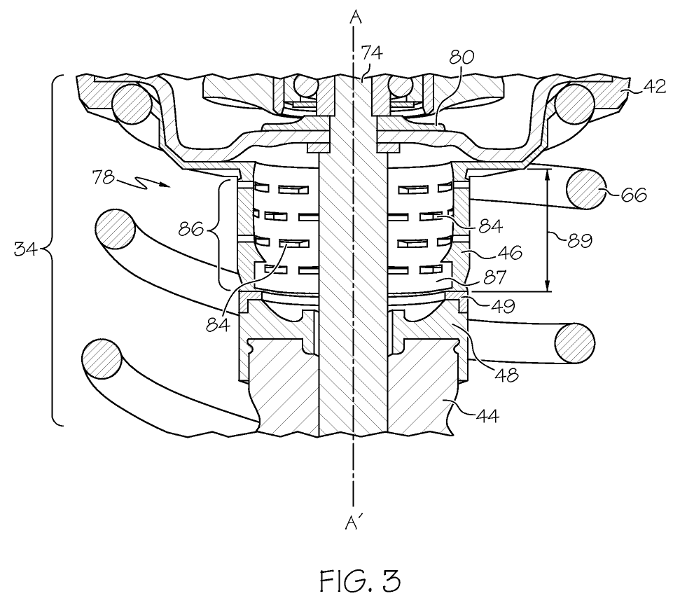

FIG. 3 is a cross-sectional isometric illustration depicting key elements of the first portion 34 of damper assembly 30 (FIG. 2) including an integrated impact bumper assembly 78 in accordance with the exemplary embodiment. First portion 34 includes upper spring seat 42, jounce bumper 44, jounce cup 48, support ring 49, impact bumper 46 having an annular wall 86, piston rod 74, and an upper mount washer 80. Coil spring 66 circumscribes sections of first and second portions 34 and 50 (FIG. 2) and is retained by upper and lower spring seats 42 and 62. Piston rod 74 is aligned axially along axis A-A′, and is rigidly coupled to upper spring seat 42 using conventional fasteners including upper mount washer 80. Jounce bumper 44, jounce cup 48, support ring 49, and impact bumper 46 together form a columnar stack that circumscribes and moves in unison with rod 74. Upper spring seat 42 and support ring 49, which may both be substantially rigid components, bound and retain impact bumper 46 interposed therebetween. Jounce bumper 44 is suitably coupled to jounce cup 48 in a conventional manner, such as by press fitting.

During normal driving conditions that do not produce excessive jounce, jounce bumper 44 and striker cap 70 (FIG. 2) remain separated by a distance that varies in accordance with the relative height of connecting suspension members. During an impact event characterized by excessive jounce, jounce bumper 44 deformably and resiliently engages against striker cap 70, absorbing at least part of the energy generated by the impact. The associated impact load is transferred through jounce bumper 44, jounce cup 48, and support ring 49 to impact bumper 46 causing bumper 46 to resiliently compress and absorb additional energy. Depending upon the severity of the impact event, this contractive motion may continue accompanied by additional deformation and increased resilience until jounce bumper 44 and impact bumper 46 each reach a maximum axial deformation. For particularly severe impact events wherein such maximum deformation is achieved, further jounce motion is prevented by the rigidity of upper spring seat 42 and striker cap 70 (FIG. 2). Impact bumper 46 is configured to respond with resilience in a spring-like manner by compressing axially when stressed by an impact load, without substantial radial deformation. Bumper 46 is configured with a plurality of openings 84 that perforate through annular wall 86 and provide a means of converting the compressive strain caused by axial loading into a bending strain within each opening. This bending strain causes openings 84 to resiliently deform enabling greater energy absorption by bumper 46 while maintaining the radial geometric stability thereof.

Impact bumper 46 may comprise any suitable resilient elastomeric polymeric material including thermosetting and thermoplastic elastomers. In one embodiment, bumper 46 comprises thermoplastic (poly)urethane rubber. In various other embodiments, openings 84 may have any size, spacing, or geometry. Such geometries include polygons having planar faces through annular wall 86 merged together at obtuse, acute, and/or right angled edges such as, for example, those of a rectangle as openings 84 of FIG. 3 depict. Openings 84 may also have curved faces through annular wall 86 such as characteristic of, for example, an ellipse or circle, or may include any combination of planar and curved faces. While terms such as rectangle, circle, or ellipse are used to describe possible shapes for openings 84, it should be understood that these descriptors include curved inner and outer faces characteristic of inner and outer surfaces of annular wall 86. Openings 84 may be arranged in any suitable manner including any number of axially aligned columns and any number of radially aligned rows. In a preferred embodiment, openings 84 are arranged in an even number of rows. Further, rows and/or columns may also be offset from each other in any manner such as in a staggered or alternating pattern. The configuration of openings will depend upon applicable design factors that may include, for example, the desired load range and/or rate of resilient response of bumper 46. In one embodiment, each of openings 84 within any row occupies a different circumferential position around the circumference of annular wall 86 than the openings of any row adjacent. In another embodiment, each line residing on an inner cylindrical surface 87 of annular wall 86, and parallel to axis A-A′, intersects at least one opening. Such a configuration helps bumper 46 to maintain a substantially constant axial dimension (represented by double-arrow line 89) around its circumference when compressed, providing greater structural stability thereto during impact events.

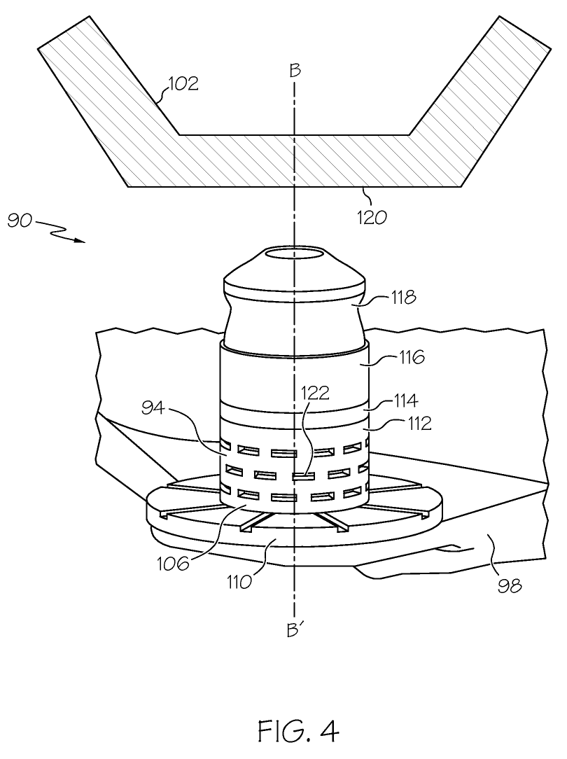

FIG. 4 is an isometric illustration of an impact bumper assembly 90 in accordance with another exemplary embodiment. Bumper assembly 90 includes an impact bumper 94 coupled to a first suspension member 98, and disposed between first suspension member 98 and a second suspension member 102. Impact bumper 94 has a first annular end 106 coupled to first suspension member 98 using any suitable means that may include a mount 110 and/or accompanying fasteners. Impact bumper assembly 90 may also optionally include other supporting elements suitably arranged such as, for example, in a columnar configuration. These may include but are not limited to a support ring 114 coupled to a second annular end 112 of impact bumper 94, a jounce cup 116 coupled to ring 114, and a jounce bumper 118 coupled to jounce cup 116. Jounce bumper 118 may be fabricated from any suitable material such as, for example, polyurethane foam or rubber. First and second suspension members 98 and 102 are configured for relative motion with each other in response to road surface conditions including contractive jounce motion that decreases their separation. During an impact event characterized by excessive jounce motion, impact bumper assembly 90 may be brought into contact with a surface 120 of second member 102. Surface 120 may be configured in any suitable manner including having a striker plate (not shown) or the like to engage impact bumper assembly 90. If further jounce motion occurs, impact bumper 94 compresses axially between members 98 and 102, substantially parallel to axis B-B′, absorbing energy from the impact load in a spring-like manner. Impact bumper 94 is configured with a plurality of openings 122 that enable such axial compression to occur without substantial radial deformation. As described above with reference to impact bumper 46 (FIG. 3), openings 122 are configured to convert the compressive strain caused by axial loading into a bending strain within each opening. This bending strain helps to substantially maintain the overall radial geometric stability of impact bumper 94 during axially loading.

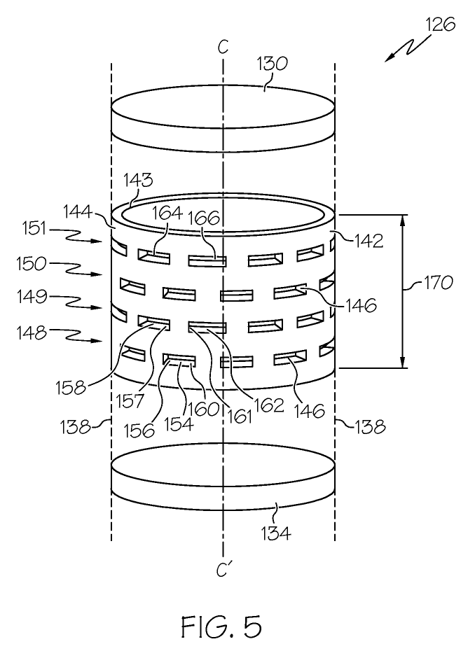

FIG. 5 is an isometric illustration of an impact bumper assembly 126 in accordance with another exemplary embodiment. Assembly 126 includes a first suspension member 130, a second suspension member 134, a cylindrical housing 138, and an annular impact bumper 142. This configuration may mimic, for example, that of a damper assembly having an outer housing and including a damper tube and an upper mount coupled between suitable suspension members such as, for example, sprung and unsprung vehicle masses. Annular impact bumper 142 is radially constrained within cylindrical housing 138 and axially bounded between suspension members 130 and 134, but may be substantially free to move axially between these limits along an axis C-C′ oriented through the center of, and parallel to, an inner cylindrical surface 143 of impact bumper 142. Members 130 and 134 are configured to move axially relative to each other in contractive and expansive motion depending upon road surface conditions. During impact events, members 130 and 134 move toward each other, engaging with and compressing annular impact bumper 142. Bumper 142 comprises a suitable resilient material such as described with reference to bumper 46 (FIG. 3) and is configured with an annular wall 144 having a plurality of openings 146 therethrough that enable axial compression to occur without substantial radial deformation in a manner previously described.

Impact bumper 142 may have any number of openings 146 arranged in any number of rows. In the example illustrated in FIG. 5, impact bumper 142 has first, second, third, and fourth rows 148-151, each row having openings centered at different axial positions (along any axis parallel to axis C-C′). In one embodiment, the ends of each of the openings from first row 148 are circumferentially overlapped by openings from at least one different row. For example, opening 154 of first row 148 has a first end 156 that circumferentially overlaps an end 157 of opening 158 of second row 149, and a second end 160 that circumferentially overlaps an end 161 of opening 162 of second row 149. First and second ends 156 and 160 of opening 154 are also similarly circumferentially overlapped by openings 164 and 166, respectively, of fourth row 151. In another embodiment, openings are arranged such that all lines residing on inner cylindrical surface 143 parallel to axis C-C′, intersect with at least one opening. The number and arrangement of openings and the amount of circumferential overlap between openings are configured such that, when compressed, impact bumper 142 maintains a substantially even axial dimension (represented by double-arrow line 170 parallel to axis C-C′) at all points around its circumference.

The various embodiments of the present invention described herein provide an impact bumper assembly for a vehicular suspension system designed to have improved energy absorption during suspension impact events. The assembly may be used between two suspension members wherein it is desirable to limit jounce motion therebetween. Such applications include integration within a damper assembly such as a shock absorber or strut, or for use as a standalone assembly mounted between suitable suspension members. The assembly includes an annular impact bumper having an annular wall with a plurality of openings therethrough. When loaded during an impact event, this design enables improved energy absorption through axial compression without substantial radial deformation. This design also enables greater spatial efficiency for both loaded and unloaded states, and exhibits reduced radial strain under loading providing for improved geometrical stability. The impact bumper's improved energy absorption and geometric stability permit the use of less rugged and more lightweight structural supporting components.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention and the legal equivalents thereof.

What is claimed is:

1. An impact bumper assembly for a vehicle comprising:
a first member;
a second member coupled to the first member and configured for relative motion therewith; and
a resilient bumper coupled to the first member and interposed between the first and second members, the resilient bumper having an annular wall having a plurality of openings therethrough, the resilient bumper configured to deform axially without substantial radial deformation when compressed between the first and second members.

2. An assembly according to claim 1, further comprising a cylindrical housing circumscribed about the resilient bumper.

3. An assembly according to claim 1, wherein the resilient bumper comprises an elastomeric polymer.

4. An assembly according to claim 3, wherein the resilient bumper comprises a thermoplastic elastomer.

5. An assembly according to claim 4, wherein the resilient bumper comprises thermoplastic polyurethane rubber.

6. An assembly according to claim 3, wherein the resilient bumper comprises a thermosetting elastomer.

7. An assembly according to claim 1, wherein at least one of the plurality of openings comprises a planar face.

8. An assembly according to claim 1, wherein at least one of the plurality of openings is rectangular.

9. An assembly according to claim 1, wherein at least one of the plurality of openings comprises a curved face through the annular wall.

10. An assembly according to claim 1, wherein the plurality of openings is arranged in an even number of rows.

11. An assembly according to claim 1, wherein the plurality of openings comprises:
a first opening disposed at a first axial position, the first opening having a first end and a second end;
a second opening disposed at a second axial position different than the first axial position, and
a third opening disposed at a third axial position different than the first axial position, and wherein the second opening circumferentially overlaps with the first end of the first opening, and the third opening circumferentially overlaps with the second end of the first opening.

12. An assembly according to claim 1, wherein the annular wall has an inner cylindrical surface having a central axis parallel thereto, and wherein each line on the inner cylindrical surface parallel to the central axis intersects at least one of the plurality of openings.

13. An assembly for absorbing impact energy in a vehicular suspension system, the assembly comprising:
a first suspension member;
a second suspension member coupled to the first suspension member and configured for relative movement therewith;
a cylindrical housing coupled to the first suspension member;
a resilient annular bumper disposed between the first and second suspension members and circumscribed by and slidable within the cylindrical housing, the resilient annular bumper having an annular wall having a plurality of openings therethrough, and wherein the plurality of openings is configured to enable the resilient annular bumper to compress axially without substantial radial deformation when the resilient annular bumper is compressed between the first and second suspension members.

14. An assembly according to claim 13, wherein the resilient annular bumper comprises an elastomer.

15. An assembly according to claim 13, wherein the plurality of openings is arranged in a plurality of rows.

16. An assembly according to claim 15, wherein the plurality of rows comprises:
a first row having a first opening, the first opening having a first end and a second end;
a second row having a second opening and a third opening, and wherein the second opening circumferentially overlaps with the first end of the first opening, and the third opening circumferentially overlaps with the second end of the first opening.

17. An assembly according to claim 16, wherein the annular wall has an inner cylindrical surface having a central axis parallel thereto, and wherein each line on the inner cylindrical surface parallel to the central axis intersects at least one opening from the plurality of openings in the first and second rows.

18. An assembly according to claim 13, wherein at least one of the plurality of openings has at least one planar face.

19. A damper assembly for a vehicular suspension system, the suspension system having a first member and a second member, the assembly comprising:
a jounce bumper coupled to the first member;
a rigid surface coupled to the second member and configured to engage with the jounce bumper; and
a resilient annular bumper coupled between the jounce bumper and the first member, the resilient annular bumper comprising an annular wall having a plurality of openings therethrough, and wherein the resilient annular bumper is configured to compress axially without substantial radial deformation when the jounce bumper engages the rigid surface.

20. An assembly according to claim 19, further comprising a cylindrical housing coupled to the first member, and wherein the resilient annular bumper is circumscribed by the cylindrical housing.
